(19) United States
(12) Patent Application Publication
(10) Pub. No.: US 2025/0274067 A1
(43) Pub. Date: Aug. 28, 2025

(54) INVERTER DRIVING DEVICE AND METHOD OF CONTROLLING SAME

(71) Applicants: Hyundai Motor Company, Seoul (KR); Kia Corporation, Seoul (KR)

(72) Inventors: Min KIM, Hwaseong-si (KR); Hong Geuk PARK, Cheonan-si (KR); Jae Ho HWANG, Hwaseong-si (KR); Tae Young CHUNG, Seongnam-si (KR); Jung Hwi KIM, Seoul (KR)

(73) Assignees: Hyundai Motor Company, Seoul (KR); Kia Corporation, Seoul (KR)

(21) Appl. No.: 18/937,442

(22) Filed: Nov. 5, 2024

(30) Foreign Application Priority Data
Feb. 22, 2024 (KR) 10-2024-0025657

(51) Int. Cl. H02P 27/12; H02P 21/22

(52) U.S. Cl. CPC H02P 27/12; H02P 21/22

(57) ABSTRACT

In an inverter driving device and method, an inverter includes plurality of legs corresponding to a plurality of phases, respectively. A controller is configured to determine an offset voltage by which an amplitude of a cosine component of a pole voltage is less than or equal to a predetermined value based on a phase voltage command and is configured to control ON/OFF states of a switch included in each of the legs by pulse width modulation in which the offset voltage is reflected.

### CROSS REFERENCE TO RELATED APPLICATION

The present application claims priority to Korean Patent Application No. 10-2024-0025657, filed Feb. 22, 2024, the entire contents of which is incorporated herein for all purposes by this reference.

### BACKGROUND OF THE PRESENT DISCLOSURE

### Field of the Present Disclosure

The present disclosure relates to an inverter driving device configured to improve nonlinearity minimizing the switching frequency component of an inverter and a method of controlling the same.

### Description of Related Art

An inverter is a component that converts DC voltage from a high-voltage battery to an AC voltage to drive a motor. Methods of driving a switch within the inverter include a pulse width modulation (PWM) method.

Pulse width modulation (PWM) methods include a space vector pulse width modulation (SVPWM) method, a discontinuous pulse width modulation (DPWM) method, and the like. The SVPWM method is a continuous modulation method, and modulates one voltage command expressed in a complex number space into an active voltage vector and a zero voltage vector with a reference space vector, unlike the sinusoidal pulse width modulation (SPWM) method which modulates three-phase voltage commands separately. The DPWM method is a discontinuous modulation method which modulates only two-phase voltage commands.

On the other hand, in a process of the inverter generating an AC output voltage from an input DC power source, the input current of the inverter may have current ripples in the switching frequency band caused by the switching of the inverter. The switching frequency band may be included in the audible frequency band, causing noise.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to minimizing the magnitude of the switching frequency component by modulation using an offset voltage, improving the noise, vibration, and harshness (NVH) performance of the inverter.

The objective of the present disclosure is not limited to the aforementioned objective, and other objectives not explicitly included herein will be clearly understood by a person having ordinary knowledge in the art from the description provided hereinafter.

To realize at least one of the objectives described above, an inverter driving device according to an exemplary embodiment of the present disclosure includes: an inverter including a plurality of legs corresponding to a plurality of phases, respectively; and a controller electrically connected to the inverter and configured to determine an offset voltage by which an amplitude of a cosine component of a pole voltage is less than or equal to a predetermined value based on a phase voltage command and control ON/OFF states of a switch included in each of the legs by pulse width modulation in which the offset voltage is reflected

For example, the controller may be configured to generate a pole voltage command by adding the offset voltage to a maximum phase voltage command, an intermediate phase voltage command, and a minimum phase voltage command of the phase voltage command, and is configured to perform the pulse width modulation based on the pole voltage command.

For example, the controller may be configured to determine the offset voltage by which the amplitude of the cosine component is less than or equal to the predetermined value based on an amplitude of a sine component of the pole voltage.

For example, the controller may be configured to determine the amplitude of the cosine component of a pole voltage according to Equation 1 by use of a first coefficient corresponding to the amplitude of the cosine component of the pole voltage, a second coefficient corresponding to an amplitude of a sine component of the pole voltage, and an order of a frequency component,

$${a}_{n} = {( - 1 )}^{n} \frac{2}{n π} {b}_{n} , \qquad [ Equation 1 ]$$

where aₙ is the first coefficient, bₙ is the second coefficient, and n is the order.

For example, the controller may be configured to determine the offset voltage that causes a differential value with respect to the square of the amplitude of the sine component of the pole voltage to be 0 as the offset voltage that causes the amplitude of the cosine component of the pole voltage to be less than or equal to the predetermined value.

For example, the controller may be configured to determine the offset voltage that causes the differential value with respect to the square of the amplitude of the sine component of the pole voltage to be 0 according to Equation 2 by use of the second coefficient, the order, a first variable defined by a relationship between the offset voltage and a direct current input voltage, a second variable and a third variable defined by a relationship between the phase voltage command and the direct current input voltage,

$$\frac{d}{d α} {( {b}_{n} )}^{2} = \frac{- 2 pq}{1 + {α}^{2}} ( α + \frac{p}{q} ) ( α + \frac{q}{p} ) , \qquad [ Equation 2 ]$$

where α indicates the first variable, p indicates the second variable, q indicates the third variable, bₙ indicates the second coefficient, and n indicates the order.

For example, the controller may be configured to determine the offset voltage that causes the differential value with respect to the square of the amplitude of the sine component of the pole voltage to be 0 by applying 1 to the value of the order in Equation 2.

To realize at least one of the objectives described above, an inverter driving method according to an exemplary embodiment of the present disclosure includes: determining an offset voltage by which an amplitude of a cosine component of a pole voltage is less than or equal to a predetermined value based on a phase voltage command; and controlling ON/OFF states of a switch included in each of legs of an inverter by pulse width modulation in which the offset voltage is reflected, the plurality of legs corresponding to a plurality of phases, respectively.

For example, the controlling may include generating a pole voltage command by adding the offset voltage to a maximum phase voltage command, an intermediate phase voltage command, and a minimum phase voltage command of the phase voltage command, and performing the pulse width modulation based on the pole voltage command.

For example, the determining of the offset voltage may determine the offset voltage by which the amplitude of the cosine component is less than or equal to the predetermined value based on an amplitude of a sine component of the pole voltage.

For example, the determining of the offset voltage may determine the amplitude of the cosine component of a pole voltage according to Equation 1 by use of a first coefficient corresponding to the amplitude of the cosine component of the pole voltage, a second coefficient corresponding to an amplitude of a sine component of the pole voltage, and an order of a frequency component,

$${a}_{n} = {( - 1 )}^{n} \frac{2}{n π} {b}_{n} , \qquad [ Equation 1 ]$$

where aₙ is the first coefficient, bₙ is the second coefficient, and n is the order.

For example, the determining of the offset voltage may determine the offset voltage that causes a differential value with respect to the square of the amplitude of the sine component of the pole voltage to be 0 as the offset voltage that causes the amplitude of the cosine component of the pole voltage to be less than or equal to the predetermined value.

For example, the determining of the offset voltage may determine the offset voltage that causes the differential value with respect to the square of the amplitude of the sine component of the pole voltage to be 0 according to Equation 2 by use of the second coefficient, the order, a first variable defined by a relationship between the offset voltage and a direct current input voltage, a second variable and a third variable defined by a relationship between the phase voltage command and the direct current input voltage,

$$\frac{d}{d α} {( {b}_{n} )}^{2} = \frac{- 2 pq}{1 + {α}^{2}} ( α + \frac{p}{q} ) ( α + \frac{q}{p} ) , \qquad [ Equation 2 ]$$

where α indicates the first variable, p indicates the second variable, q indicates the third variable, bₙ indicates the second coefficient, and n indicates the order.

For example, the determining of the offset voltage may determine the offset voltage that causes the differential value with respect to the square of the amplitude of the sine component of the pole voltage to be 0 by applying 1 to the value of the order in Equation 2.

According to the various embodiments of the present disclosure as described above, the switching frequency component according to the switching of the inverter may be reduced, improving the noise, vibration, and harshness (NVH) performance of the inverter.

Modulation using an offset voltage can reduce the switching frequency component without using separate passive elements, reducing the price and volume increase of the control system.

Furthermore, modulation using an offset voltage can reduce the switching frequency component without increasing the switching loss, ensuring the efficiency of the overall system.

The effects of the present disclosure are not limited to the aforementioned effects, and other effects not explicitly included herein will be clearly understood by a person having ordinary knowledge in the art from the description provided hereinafter.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating the configuration of an inverter driving device in a motor driving system to which embodiments of the present disclosure are applicable.

FIG. 2 is a diagram illustrating the configuration of a controller according to an exemplary embodiment of the present disclosure.

FIG. 3 is a diagram illustrating a control process using an offset voltage according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural and functional descriptions of embodiments of the present disclosure included in the present specification or application are illustrative only for describing the exemplary embodiments according to an exemplary embodiment of the present disclosure, and the exemplary embodiments of the present disclosure may be implemented in various forms and should not be construed as being limited to various exemplary embodiments described in the present specification or application.

The exemplary embodiments of the present disclosure may be variously modified and may have various forms, so that specific embodiments will be illustrated in the drawings and be described in detail in the present specification or application. It should be understood, however, that it is not intended to limit the exemplary embodiments according to the concept of the present disclosure to specific disclosure forms, but it includes all modifications, equivalents, and alternatives falling within the spirit and scope of the present disclosure.

Unless defined otherwise, all terms including technical or scientific terms used herein include the same meaning as commonly understood by those skilled in the art to which the present disclosure pertains. General terms that are defined in a dictionary shall be construed to have meanings that are consistent in the context of the relevant art, and will not be interpreted as having an idealistic or excessively formalistic meaning unless clearly defined in the present disclosure.

Hereinafter, various exemplary embodiments included in the present specification will be described in detail with reference to the accompanying drawings, in which identical or similar constituent elements are provided the same reference numerals regardless of the reference numerals of the drawings, and a repeated description thereof will be omitted.

In the following description of embodiments, when a parameter is referred to as being “predetermined,” it may be intended to mean that a value of the parameter is determined in advance when the parameter is used in a process or algorithm. The value of the parameter may be set before the process or algorithm is started or may be set in a period during which the process or algorithm is executed.

Terms “module” and “part” used in the following description are provided or mixed together only considering the ease of generating the specification, and have no meanings or roles that are distinguished from each other by themselves.

In the description of the present disclosure, when it is determined that the detailed Description of Related Art would obscure the gist of the present disclosure, the detailed description thereof will be omitted. Furthermore, the appended drawings are merely intended to be able to readily understand the exemplary embodiments disclosed herein, and thus the technical idea disclosed herein is not limited by the appended drawings, and it should be understood to include all changes, equivalents, and substitutions included in the idea and technical scope of the present disclosure.

It will be understood that, although terms “first”, “second”, etc., may be used herein to describe various elements, these elements should not be limited by these terms. These terms are only used to distinguish one element from another element.

It will be understood that when an element is referred to as being “coupled” or “connected” to another element, it may be directly coupled or connected to the other element or intervening elements may be present therebetween. In contrast, it should be understood that when an element is referred to as being “directly coupled” or “directly connected” to another element, there are no intervening elements present.

As used herein, singular forms are intended to include the plural forms as well, unless the context clearly indicates otherwise.

It will be further understood that terms “comprise”, “include”, “have”, etc., when used in the present specification, specify the presence of stated features, integers, steps, operations, elements, components, and/or combinations thereof but do not preclude the presence or addition of one or more other features, integers, steps, operations, elements, components, and/or combinations thereof.

Furthermore, a term such as “unit” or “control unit” included in the names of some elements, such as a motor control unit (MCU) and a hybrid control unit (VCU), is only a term widely used in naming of a controller that is configured to control a specific function of a vehicle but should not be understood as indicating a generic function unit.

A controller may include a communication device communicating with another controller or a sensor to control a function which the controller manages, a memory storing an operating system, logic instructions, input/output information, and the like, and one or more processors performing determination, calculation, decision, and the like necessary for controlling the function.

An inverter driving device and an inverter driving method according to an exemplary embodiment of the present disclosure are intended to improve the noise, vibration, and harshness (NVH) performance of an inverter by minimizing the switching frequency component by pulse width modulation (PWM) using an offset voltage determined based on a phase voltage command.

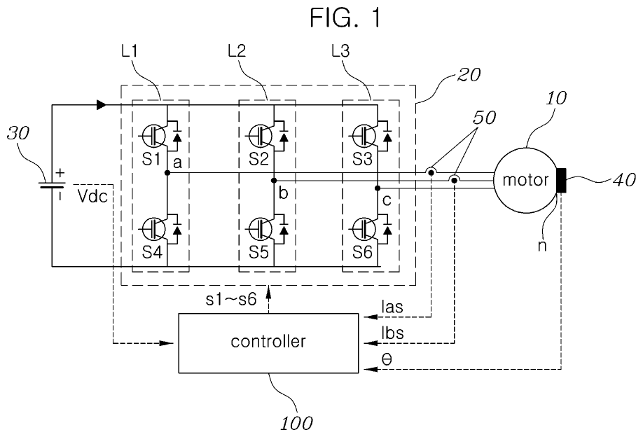

Hereinafter, first, the configuration of an inverter driving device to which embodiments of the present disclosure are applicable will be described with reference to FIG. 1.

FIG. 1 is a diagram illustrating the configuration of an inverter driving device in a motor driving system to which embodiments of the present disclosure are applicable.

Referring to FIG. 1, a motor driving system to which embodiments of the present disclosure are applicable may include a motor 10, an inverter 20, a battery 30, and a controller 100.

The motor 10 may include a plurality of windings corresponding to a plurality of phases, respectively. First ends of the plurality of windings may be short-circuited to each other to form a neutral point, and second ends of the plurality of windings may be connected to alternating current (AC) terminals a, b, and c of the inverter 20, respectively.

The inverter 20 may include a plurality of legs L1, L2, and L3 corresponding to the plurality of phases, respectively. The plurality of legs L1, L2, and L3 may include switches S1 and S4, switches S2 and S5, and switches S3 and S6, respectively. The plurality of legs L1, L2, and L3 may be connected to direct current (DC) terminals, respectively, to receive a DC voltage Vdc from the battery 30, and may convert the DC voltage Vdc to AC voltages corresponding to the plurality of phases and provide the AC voltages to the AC terminals a, b, and c, respectively to drive the motor 10.

The controller 100 may be configured to determine a phase voltage command for the inverter 20 based on a required torque for the motor 10 and then determine a pole voltage command for the inverter 20 from the phase voltage command. Here, a phase voltage corresponds to a potential difference between a neutral point n and the AC terminals a, b, and c, and a pole voltage corresponds to a potential difference between a ground terminal g and the AC terminals a, b, and c.

The controller 100 may be configured to generate a pulse width modulation (PWM) signal by modulating the pole voltage command by pulse width modulation and then output the same as switching signals s1, s2, s3, s4, s5 and s6. The controller 100 may drive the inverter 20 by controlling the turn-on states of the switches S1, S2, S3, S4, S5 and S6 included in the plurality of legs L1, L2, and L3 based on the switching signals s1, s2, s3, s4, s5 and s6.

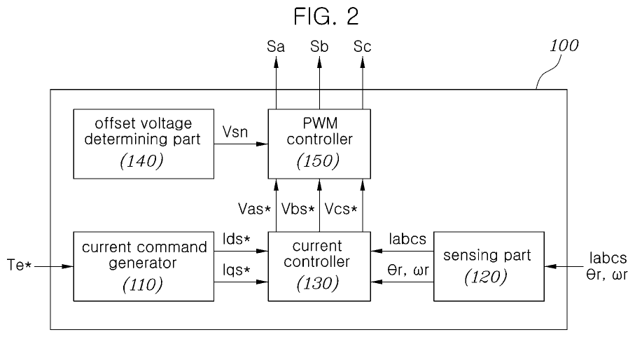

The controller 100 may reflect an offset voltage in generating the pole voltage command, and these features will be described with reference to FIG. 2.

FIG. 2 is a diagram illustrating the configuration of a controller according to an exemplary embodiment of the present disclosure.

Referring to FIG. 2, the controller 100 according to an exemplary embodiment of the present disclosure may include a current command generator 110, a sensing part 120, a current controller 130, an offset voltage determining portion 140, and a PWM controller 150.

First, the current command generator 110 may be configured to generate d-q axis current commands Ids* and Iqs* based on a motor required torque Te*.

The sensing part 120 may obtain a rotation angle θr and a rotation speed or of the motor from, for example, a resolver 40 connected to the motor 10, and obtain current sensing values Iabcs, i.e., Ias, Ibs, and Ics of the respective phases from current sensors 50 connected to the motor 10 and inverter 20.

The current controller 130 may be configured to generate phase voltage commands Vas*, Vbs*, and Vcs* based on the d-q axis current commands Ids* and Iqs*, the current sensing values Ias, Ibs, and Ics of the respective phases, and the rotation angle θr and rotation speed or of the motor, and transmit the generated phase voltage commands Vas*, Vbs*, and Vcs* to the PWM controller 150.

The PWM controller 150 may be configured for controlling ON/OFF states of the switches S1, S2, S3, S4, S5 and S6 included in the plurality of legs L1, L2, and L3 of the inverter 20 by pulse width modulation based on the received phase voltage commands Vas*, Vbs*, and Vcs*.

Furthermore, in the inverter drive control according to an exemplary embodiment of the present disclosure, the offset voltage determining portion 140 may be configured to determine an offset voltage by which the amplitude of the cosine component of the pole voltage is less than or equal to a predetermined value based on the phase voltage commands Vas*, Vbs*, and Vcs*, and the PWM controller 150 may be configured for controlling the ON/OFF states of the switches S1, S2, S3, S4, S5 and S6 included in the plurality of legs L1, L2, and L3, respectively, by pulse width modulation in which the offset voltage is reflected.

The PWM controller 150 may be configured to generate a pole voltage command by adding an offset voltage to a maximum phase voltage command, an intermediate phase voltage command, and a minimum phase voltage command among the phase voltage commands, and perform pulse width modulation based on the pole voltage command.

In the instant case, the offset voltage determining portion 140 may be configured to determine an offset voltage that causes the amplitude of the cosine component to be less than or equal to the predetermined value based on the amplitude of the sine component of the pole voltage.

In this regard, the offset voltage determining portion 140 may be configured to determine the amplitude of the cosine component of a pole voltage according to the equation below by use of a first coefficient corresponding to the amplitude of the cosine component of the pole voltage, a second coefficient corresponding to the amplitude of the sine component of the pole voltage, and the order of the frequency component.

$${a}_{n} = {( - 1 )}^{n} \frac{2}{n π} {b}_{n}$$

Here, an is the first coefficient, bₙ is the second coefficient, and n is the order.

The first coefficient and the second coefficient may be derived through the Fourier series expansion, and represent the size of the cosine component and the size of the sine component, respectively.

Because the DC input current of the inverter 20 includes a symmetrical even function during a single switching cycle, the total sum of the sine components within the cycle may be “0”, and accordingly, the first coefficient representing the size of the cosine component may be used to minimize the switching frequency component.

According to the equation above, because the first coefficient and the second coefficient are in a relationship in which their squares are proportional to each other, the offset voltage determining portion 140 may be configured to determine the offset voltage that causes the differential value with respect to the square of the amplitude of the sine component of the pole voltage to be 0 as the offset voltage that causes the amplitude of the cosine component of the pole voltage to be below the predetermined value.

In the instant case, the offset voltage determining portion 140 may be configured to determine the offset voltage that causes the differential value with respect to the square of the amplitude of the sine component of the pole voltage to be 0 according to the equation below by use of a first variable defined by a relationship between the offset voltage and the DC input voltage, a second variable and a third variable defined by a relationship between the phase voltage command and the DC input voltage, the second coefficient, and the order of frequency.

$$\frac{d}{d α} {( {b}_{n} )}^{2} = \frac{- 2 p q}{1 + {α}^{2}} ( α + \frac{p}{q} ) ( α + \frac{q}{p} )$$

Here, α indicates the first variable, p indicates the second variable, q indicates the third variable, bₙ indicates the second coefficient, and n indicates the order.

A relationship between the offset voltage Vsn and the DC input voltage Vdc may be defined as

$$α = tan \frac{V s n}{V dc} n π ,$$

and the second variable p and the third variable q defined by a relationship between the phase current ik, the phase voltage command Vk (k=max, mid, min) and the DC input voltage may be expressed as

$$p = \sum ( ik \cdot sin \frac{V k + 0.5 V dc}{V dc} n π ) and q =$$

$$\sum ( ik \cdot cos \frac{Vk + 0.5 V dc}{V dc} n π ) .$$

Furthermore, the offset voltage determining portion 140 may be configured to determine the offset voltage that causes the differential value with respect to the square of the amplitude of the sine component of the pole voltage to be 0 by applying “1” to the value of the order in the equation

$$\frac{d}{d α} {( {b}_{n} )}^{2} = \frac{- 2 pq}{1 + {α}^{2}} ( α + \frac{p}{q} ) ( α + \frac{q}{p} ) .$$

When pulse width modulation control is performed using the offset voltage that causes the amplitude of the cosine component of the pole voltage to be less than or equal to a predetermined value as described above, the noise, vibration, and harshness (NVH) performance of the inverter 20 may be improved by suppressing the switching component.

As a result of the pulse width modulation to which the offset voltage determined using ‘1’ as the order is applied, the component around 8 kHz corresponding to the switching frequency may be suppressed, which may be observed by simulation using the Fast Fourier Transform (FFT).

Because the switching frequency around 8 kHz is included in the audible frequency range, as the switching frequency is suppressed, the noise generated by the switching operation of the inverter 20 is alleviated and the noise, vibration, and harshness (NVH) performance may be improved.

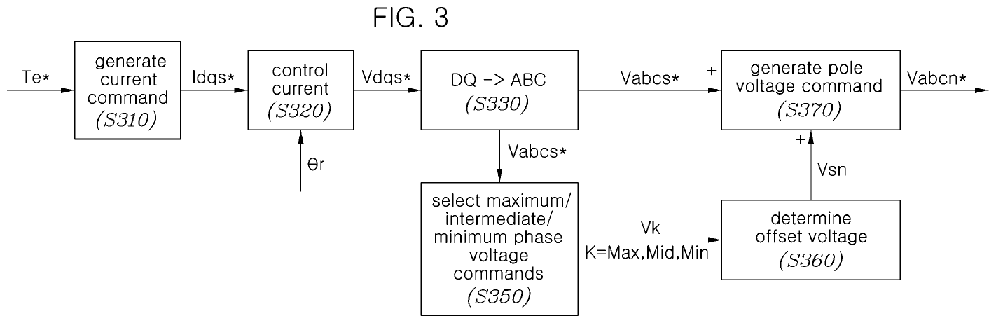

Furthermore, the process of generating a pole voltage command by applying an offset voltage will be described below with reference to FIG. 3.

FIG. 3 is a diagram illustrating a control process using an offset voltage according to an exemplary embodiment of the present disclosure.

Referring to FIG. 3, first, the controller 100 may be configured to generate a d-q axis current command Idqs* based on the motor required torque Te* in S310, and may be configured to generate a d-q axis voltage command Vdqs* based on a sensor value, such as the rotation angle θr of the motor, and the generated d-q axis current command Idqs* in S320.

Thereafter, the controller 100 may convert the generated d-q axis voltage command Vabcn to a phase voltage command Vabcs* to generate a pole voltage command in S330, and may select a maximum phase voltage command Vmax, an intermediate phase voltage command Vmid, and a minimum phase voltage command Vmin from the converted phase voltage command Vabcs* in S350.

The controller 100 is configured to determine the offset voltage Vsn in S360, and generates a pole voltage command Vabcn* by adding the offset voltage Vsn to the selected maximum phase voltage command Vmax, intermediate phase voltage command Vmid, and minimum phase voltage command Vmin in S370. In the instant case, the offset voltage Vsn may be determined so that the amplitude of the cosine component of the pole voltage is less than or equal to a predetermined value.

To ensure that the amplitude of the cosine component of the pole voltage is less than or equal to the predetermined value, the controller 100 may be configured to determine the offset voltage based on the amplitude of the sine component of the pole voltage. Details of the method of determining an offset voltage that causes the amplitude of the cosine component of the pole voltage to be less than or equal to a predetermined value based on the amplitude of the sine component of the pole voltage have been described above with reference to FIG. 2.

According to the various embodiments of the present disclosure as described above, the switching frequency component according to the switching of the inverter may be reduced, improving the noise, vibration, and harshness (NVH) performance of the inverter.

, modulation using an offset voltage can reduce the switching frequency component without using separate passive elements, reducing the price and volume increase of the control system.

Furthermore, modulation using an offset voltage can reduce the switching frequency component without increasing the switching loss, ensuring the efficiency of the overall system.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An inverter driving apparatus comprising:
an inverter including a plurality of legs corresponding to a plurality of phases, respectively; and
a controller electrically connected to the inverter and configured to determine an offset voltage by which an amplitude of a cosine component of a pole voltage is less than or equal to a predetermined value based on a phase voltage command and control ON/OFF states of a switch included in each of the legs by pulse width modulation in which the offset voltage is reflected.

2. The inverter driving apparatus of claim 1, wherein the controller is further configured to generate a pole voltage command by adding the offset voltage to a maximum phase voltage command, an intermediate phase voltage command, and a minimum phase voltage command of the phase voltage command, and to perform the pulse width modulation based on the pole voltage command.

3. The inverter driving apparatus of claim 1, wherein the controller is further configured to determine the offset voltage by which the amplitude of the cosine component is less than or equal to the predetermined value based on an amplitude of a sine component of the pole voltage.

4. The inverter driving apparatus of claim 1, wherein the controller is further configured to determine the amplitude of the cosine component of the pole voltage based on Equation 1 by use of a first coefficient corresponding to the amplitude of the cosine component of the pole voltage, a second coefficient corresponding to an amplitude of a sine component of the pole voltage, and an order of a frequency component,
$${a}_{n} = {( - 1 )}^{n} \frac{2}{n π} {b}_{n} , \qquad [ Equation 1 ]$$
where aₙ is the first coefficient, bₙ is the second coefficient, and n is the order.

5. The inverter driving apparatus of claim 4, wherein the controller is further configured to determine the offset voltage that causes a differential value with respect to the square of the amplitude of the sine component of the pole voltage to be 0 as the offset voltage that causes the amplitude of the cosine component of the pole voltage to be less than or equal to the predetermined value.

6. The inverter driving apparatus of claim 5, wherein the controller is further configured to determine the offset voltage that causes the differential value with respect to the square of the amplitude of the sine component of the pole voltage to be 0 based on Equation 2 by use of the second coefficient, the order, a first variable defined by a relationship between the offset voltage and a direct current input voltage, a second variable and a third variable defined by a relationship between the phase voltage command and the direct current input voltage,
$$\frac{d}{d α} {( {b}_{n} )}^{2} = \frac{- 2 pq}{1 + {α}^{2}} ( α + \frac{p}{q} ) ( α + \frac{q}{p} ) , \qquad [ Equation 2 ]$$
where α indicates the first variable, p indicates the second variable, q indicates the third variable, b₁ indicates the second coefficient, and n indicates the order.

7. The inverter driving apparatus of claim 6, wherein the controller is further configured to determine the offset voltage that causes the differential value with respect to the square of the amplitude of the sine component of the pole voltage to be 0 by applying 1 to the value of the order in Equation 2.

8. An inverter driving method including:
determining, by a controller, an offset voltage by which an amplitude of a cosine component of a pole voltage is less than or equal to a predetermined value based on a phase voltage command; and
controlling, by the controller, ON/OFF states of a switch included in each of legs of an inverter electrically connected to the controller, by pulse width modulation in which the offset voltage is reflected, the plurality of legs corresponding to a plurality of phases, respectively.

9. The inverter driving method of claim 8, wherein the controlling includes generating a pole voltage command by adding the offset voltage to a maximum phase voltage command, an intermediate phase voltage command, and a minimum phase voltage command of the phase voltage command, and performing the pulse width modulation based on the pole voltage command.

10. The inverter driving method of claim 8, wherein the determining of the offset voltage includes determining the offset voltage by which the amplitude of the cosine component is less than or equal to the predetermined value based on an amplitude of a sine component of the pole voltage.

11. The inverter driving method of claim 8, wherein the determining of the offset voltage includes determining the amplitude of the cosine component of the pole voltage based on Equation 1 by use of a first coefficient corresponding to the amplitude of the cosine component of the pole voltage, a second coefficient corresponding to an amplitude of a sine component of the pole voltage, and an order of a frequency component,
$${a}_{n} = {( - 1 )}^{n} \frac{2}{n π} {b}_{n} , \qquad [ Equation 1 ]$$
where aₙ is the first coefficient, bₙ is the second coefficient, and n is the order.

12. The inverter driving method of claim 11, wherein the determining of the offset voltage includes determining the offset voltage that causes a differential value with respect to the square of the amplitude of the sine component of the pole voltage to be 0 as the offset voltage that causes the amplitude of the cosine component of the pole voltage to be less than or equal to the predetermined value.

13. The inverter driving method of claim 12, wherein the determining of the offset voltage includes determining the offset voltage that causes the differential value with respect to the square of the amplitude of the sine component of the pole voltage to be 0 based on Equation 2 by use of the second coefficient, the order, a first variable defined by a relationship between the offset voltage and a direct current input voltage, a second variable and a third variable defined by a relationship between the phase voltage command and the direct current input voltage,
$$\frac{d}{d α} {( {b}_{n} )}^{2} = \frac{- 2 pq}{1 + {α}^{2}} ( α + \frac{p}{q} ) ( α + \frac{q}{p} ) , \qquad [ Equation 2 ]$$
where α indicates the first variable, p indicates the second variable, q indicates the third variable, bₙ indicates the second coefficient, and n indicates the order.

14. The inverter driving method of claim 13, wherein the determining of the offset voltage includes determining the offset voltage that causes the differential value with respect to the square of the amplitude of the sine component of the pole voltage to be 0 by applying 1 to the value of the order in Equation 2.

15. A non-transitory computer-readable recording medium having recorded thereon a program to cause the inverter driving method of claim 8 to be executed.
